(19) United States
(12) Patent Application Publication
(10) Pub. No.: US 2018/0023737 A1
(43) Pub. Date: Jan. 25, 2018

(54) PORT FLANGE FOR A HEAT EXCHANGER AND METHOD OF MAKING A PORT FLANGE

(71) Applicant: TITANX ENGINE COOLING HOLDING AB, Sölvesborg (SE)

(72) Inventors: Brice Joly, Reze (FR); Ryan Nistal, Norrköping (SE)

(73) Assignee: TITANX ENGINE COOLING HOLDING AB, Sölvesborg (SE)

(21) Appl. No.: 15/550,001

(22) PCT Filed: Feb. 5, 2016
(86) PCT No.: PCT/EP2016/052514

§ 371 Date: Aug. 9, 2017

(30) Foreign Application Priority Data
Feb. 9, 2015 (SE) 1550140-6

(51) Int. Cl. F16L 23/02; B23K 1/00; B23P 11/00; F28F 9/02; B23P 15/26

(52) U.S. Cl. CPC F16L 23/02; F28F 9/0248; F28F 9/0251; F28F 9/0256; B23P 15/26; B23P 11/00; B23K 1/00

(57) ABSTRACT

The present document discloses a port flange for a heat exchanger. The port flange comprises a heat exchanger mounting portion (83), for connection to a heat exchanger plate, a system interface portion (82), comprising a flange for connection to a system that is to supply or receive a medium to/from the heat exchanger, and a port channel (84), for connecting an opening in the system interface portion to the heat exchanger mounting portion. At least part of the port channel (84) is formed from a first piece of material (86), the flange is formed of a second piece of material (82), and the first piece of material is permanently joined to the second piece of material

### TECHNICAL FIELD

The present disclosure relates to port flanges, and more particularly to port flanges for heat exchangers which are suitable for use as oil coolers in heavy vehicles.

The disclosure also relates to methods of forming such port flanges.

### BACKGROUND

Port flanges for heat exchangers are mounted between a heat exchanger and a system, e.g. an engine block, machine body or a pipe, in order to provide a leak tight connection for cooling medium and/or oil flowing between the system and the heat exchanger. The port flange may consist of one or several parts and is usually attached to the system by attachment devices such as screws, rivets or bolts and is brazed or welded onto the heat exchanger.

It is desirable to provide a port flange which is easy and cost efficient to manufacture and easy to mount between the heat exchanger and the engine interface. Moreover, in order to provide leak tightness, the port flange needs to be resistant towards thermal and mechanical forces to which the port flange is subjected upon mounting and when the heat exchanger is in use.

Prior art port flanges are conventionally in one solid metal piece, e.g. of stainless steel, and may comprise a system interface portion, a heat exchanger mounting portion, one through port channel extending between the system interface portion and the heat exchanger portion, for transport of e.g. cooling medium and/or oil. Furthermore the port flange may have at least one, preferably two, mounting recesses which are accessible from the system interface portion.

These port flanges may have a generally elongate shape with the through port channel positioned at the center and with the two mounting recesses positioned at each side of the opening for the port channel in the system interface portion. These port flanges are usually manufactured by forging and/or milling. Two examples of prior art port flanges, 1, 1′ are shown in FIGS. 1a-1b each comprising a system interface portion 12, 12′, a heat exchanger mounting portion 13, 13′, one through port channel 14, 14′ and at least one, preferably two, mounting recesses 15, 15′. A further example of a port flange, which is mounted by brazing onto a heat exchanger, is disclosed in EP 1 676 089 B1.

However, there is further need for an improved port flange which is manufactured in a more cost-efficient way and which is manufactured with improved and even quality.

### SUMMARY

It is an object to provide an improved port flange which alleviate or eliminate the drawbacks of prior art.

The invention is defined by the appended independent claims. Embodiments are set forth in the appended dependent claims and in the following description and in the drawings.

According to a first aspect, there is provided a port flange for a heat exchanger comprising a heat exchanger mounting portion, for connection to a heat exchanger plate, a system interface portion, comprising a flange for connection to a system that is to supply or receive a medium to/from the heat exchanger, and a port channel, for connecting an opening in the system interface portion to the heat exchanger mounting portion. At least part of the port channel is formed from a first piece of material. The flange is formed of a second piece of material. The first piece of material is permanently joined to the second piece of material.

A port channel formed by a pair of thus joined pieces of material may provide a reduction of material waste as compared to a port flange which is machined from a single piece of material.

The first piece of material may be a tubular part.

The second piece of material is a substantially planar part.

The first piece of material may be joined to the second piece of material by an operation comprising heat treatment of at least one of the materials, such as a brazing, soldering or welding operation.

According to a second aspect there is provided a port flange for a heat exchanger, comprising a heat exchanger mounting portion, a system interface portion, at least one port channel connecting respective openings in the heat exchanger mounting portion and the system interface portion, and at least one mounting recess which is accessible from the system interface portion.

The port flange presents a space, which is situated between the port channel and the mounting recess and which has lower density than the heat exchanger mounting portion and/or the system interface portion.

The heat exchanger mounting portion of the port flange is a portion providing a leak tight connection/interface between a heat exchanger and the port flange.

The system interface portion is a portion of the port flange providing a leak tight connection/interface between a system, e.g. an engine block, machine body or a pipe, and the port flange.

The port channel is a through channel providing a connection between an opening in the system interface portion and an opening in the heat exchanger portion, hence a connection between the system and the heat exchanger.

The mounting recess is a recess arranged for receiving attachment devices, e.g. screws, bolts or rivets, such that the port flange can be attached to the system and optionally also to the heat exchanger.

The space may be a hollow space or cavity, or it may comprise a material which has lower density as compared to the material of which the system interface and/or the heat exchanger mounting portion is made of.

Advantages by such a port flange may be that it may be lighter which is highly desirable in the automotive industry. By the use of less material/less expensive material upon production, the port flange may be more cost efficient to manufacture. Moreover, the waste of material upon production of the port flange may be reduced.

The mounting recess may be formed by a separate part, which is permanently joined to the system interface portion.

The separate part may comprise a second sleeve having an internal recess forming the mounting recess.

The second sleeve may have a length that is smaller than a total thickness of the port flange.

The system interface portion may be formed from a first generally planar member, having a thickness which is less than a total thickness of the port flange.

An advantage by the use of a general planar member is that less material may be wasted during production of the port flange.

The port channel may be at least partially formed in one piece with the planar member.

An edge portion of the first generally planar member may present a ridge providing increased stiffness.

The edge portion may be shorter than the total length of the port flange, or it may have the same length as the port flange, thereby contacting the heat exchanger.

An advantage by this is that the port flange may become more rigid and thereby may be easier to mount between a system and a heat exchanger. By improved rigidity, the port flange may be more resistant towards thermal and mechanical forces to which the port flange is subjected to upon mounting and when the heat exchanger is in use.

The port channel may be formed by a separate part, which may be permanently joined to the system interface portion.

The separate part may be provided by a sleeve, a pipe or a rod.

The separate part may comprise at least one shoulder, which may be adapted for mechanical interconnection with at least one of the system interface portion and the heat exchanger mounting portion.

An advantage by such a shoulder is that it may increase the strength of the connection between the separate part and the system interface portion and/or the heat exchanger mounting portion.

The separate part may comprise a first sleeve which may have a length corresponding to a total thickness of the flange.

The first sleeve may have an internal cavity forming the port channel.

The separate part comprises a second sleeve which may have an internal recess forming the mounting recess. Such an internal recess may have the form of a through recess or through hole, or a bottom recess or bottom hole.

The second sleeve may have a length that is smaller than a total thickness of the flange.

The heat exchanger mounting portion may be formed from a generally planar member, having a thickness which is less than a total thickness of the port flange.

The generally planar member may present a shape and a thickness which are substantially the same as those of the system interface portion.

The generally planar member may present a thickness which is smaller than that of a generally planar member forming the system interface portion.

The generally planar member may present a portion which is bent so as to extend out of a principal plane of the generally planar member and towards the system interface portion.

The bent portion may contact the system interface portion.

The bent portion may form at least part of the port channel.

The bent portion may present a surface portion that extends in a plane parallel with, and spaced from, the principal plane.

The port flange may further comprise an enclosing member, which extends between a periphery of the system interface portion and a periphery of the heat exchanger mounting portion.

This configuration may especially be suitable for large port flanges due to the plurality of mounting recesses.

The bent portion may form at least part of a locking tongue.

A locking tongue may be defined as a portion of the heat exchanger mounting portion which may connect a flange of a sleeve for a mounting recess to the heat exchanger mounting portion.

According to a third aspect there is provided a heat exchanger having at least one port flange mounted thereon.

According to a fourth aspect, there is provided a method of forming a port flange for a heat exchanger, comprising a heat exchanger mounting portion, for connection to a heat exchanger plate, a system interface portion, comprising a flange for connection to a system that is to supply or receive a medium to/from the heat exchanger, and a port channel, for connecting an opening in the system interface portion to the heat exchanger mounting portion. The method comprises forming at least part of the port channel from a first piece of material, forming the flange from a second piece of material, and permanently joining the first piece of material to the second piece of material.

The first piece of material may be formed from a substantially planar blank, such as a metal sheet.

The second piece of material may be formed from an elongate member forming a channel, such as a sleeve.

According to a fifth aspect, there is provided a method of forming a port flange for a heat exchanger, the flange comprising a system interface portion, a port channel extending from a first opening in the system interface portion, and a heat exchanger mounting portion for mounting the port flange to a heat exchanger. The method comprises forming at least two of the system interface portion, the port channel and the mounting portion from two different parts, and assembling the two parts to form the port flange. At least one, preferably both, of the parts is formed from a planar blank, such as a metal sheet, such as by stamping, pressing or deep drawing.

According to a sixth aspect there is provided a method of forming a port flange for a heat exchanger, the flange comprises a system interface portion, a port channel extending from a first opening in the system interface portion, and at least one mounting recess, extending from a second opening in the system interface portion. The method comprises providing a first part defining the system interface portion and having the first opening and the second opening, providing a sleeve defining a recess, attaching the sleeve to the first part such that the first or second opening provides access to the recess, thus forming at least one of the port channel and the mounting recess 2, and providing the other one of the port channel and the mounting recess such that the port flange presents a space, which is situated between the port channel and the mounting recess and which has lower density than the heat exchanger mounting portion and/or the system interface portion.

The other one of the port channel and the mounting recess may be provided at least partially by forming the system interface portion.

An advantage may be that less material may be wasted upon production.

The system interface portion and/or the heat exchanger mounting portion may be formed by pressing, stamping or deep drawing a plate, or by forging, molding, casting or sintering a piece of material.

An advantage may be that less material is wasted upon production. The permanently joining may be provided by a process comprising heating at least part of the first and second pieces of material, such as brazing, soldering or welding.

The parts forming the port flange may be joined simultaneously with the assembly of the heat exchanger.

### DESCRIPTION OF THE DRAWINGS

FIG. 1a is a schematic side view of a port flange according to prior art.

FIG. 1b is a cross sectional view of the port flange of FIG. 1a.

FIG. 1c is a schematic side view of an additional port flange according to prior art.

FIG. 1d is a cross sectional view of the port flange of FIG. 1c.

FIG. 2a is a schematic side view of a port flange according to a first embodiment.

FIG. 2b is a cross sectional view of the port flange of FIG. 2a.

FIG. 3a is a schematic side view of a port flange according to a second embodiment.

FIG. 3b is a cross sectional view of the port flange of the port flange of FIG. 3a.

FIG. 4a is a schematic side view of a port flange according to a third embodiment.

FIG. 4b is a cross sectional view of the port flange of FIG. 4a.

FIG. 5a is a schematic side view of a port flange according to a fourth embodiment.

FIG. 5b is a cross sectional view of the port flange of FIG. 5a.

FIG. 6a is a schematic side view of a port flange according to a fifth embodiment.

FIGS. 6b and 6c are cross sectional views of the port flange of FIG. 6a.

FIG. 7a is a schematic side view of a port flange according to a sixth embodiment.

FIG. 7b is a cross sectional view of the port flange of FIG. 7a.

FIG. 8 is a schematic cross sectional view of a port flange according to a further embodiment.

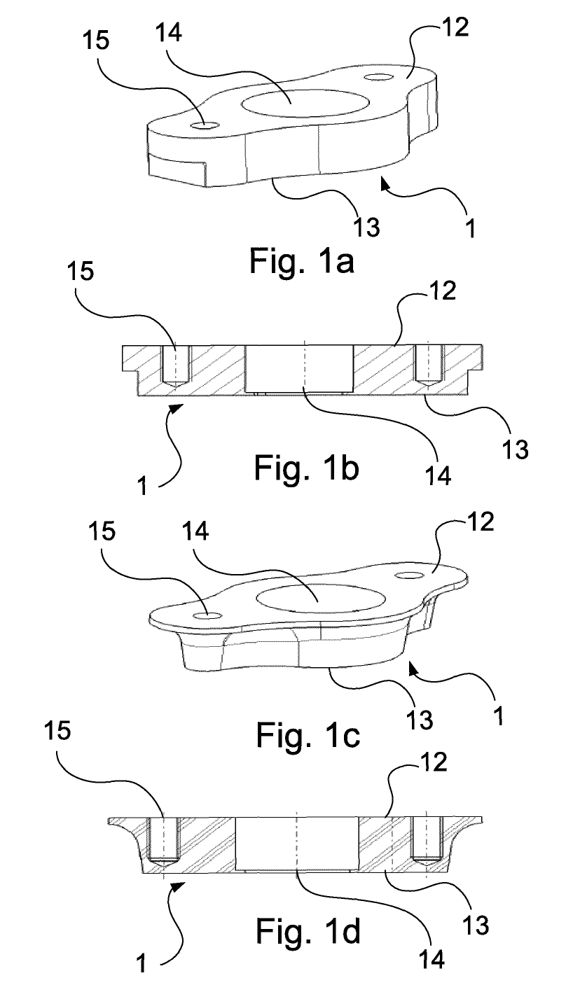

### DETAILED DESCRIPTION

A port flange 2, 3, 4, 5, 6, 7 according to the present disclosure provides an interface for a leak tight connection between a heat exchanger, in particular a plate stack forming part of a heat exchanger, and a system, e.g. an engine block, a machine body or a pipe.

The port flange has a system interface portion 22, 32, 42, 52, 62′, 72, at least one through port channel 24, 34, 44, 54, 64, 74 and at least one, preferably at least two, mounting recesses 25, 35, 45, 55, 65, 75.

The port flange may, but need not, have a separate heat exchanger mounting portion 23, 33, 53, 63, 73. As an alternative, the heat exchanger mounting portion may be provided by a part of the system interface portion 43 or by one or more of the sleeves.

The port flange presents a space 28, 38, 48, 58, 68, 78, which is at least partially situated between the through port channel and one of the mounting recesses. The space may be a hollow space/cavity, or as an alternative it may include a material different from the material(s) which the system interface and/or the heat exchanger mounting portion is made of. Preferably such material has a lower density as compared to the material(s) of the system interface portion and the heat exchanger mounting portion.

An example of a material with lower density is air. Alternatively, metal foam or sintered powder may be used. The latter examples may be used e.g. for structural integrity reasons.

The system interface portion provides a system interface surface 22′, 32′, 42′, 52′, 62′″, 72′, which is intended for providing a sealed contact against the system. This system interface surface may, but need not, be a planar surface. Importantly, the system interface surface has shape and size adapted for connection to the system, possibly with a sealing device (sealing gasket, sealing compound, etc.) arranged there between.

The system interface portion has at least one opening, or through hole, for the mounting recess(es) and at least one opening, or through hole, for the through port channel.

The openings for mounting recesses 25, 35, 45, 55, 65, 75 are, preferably uniformly positioned at a distance from the opening of the port channel 24, 34, 44, 54, 64, 74. For example, the openings and associated mounting recesses may be positioned at the same radial distance from a center of the port channel opening and, where more than one, positioned at angular intervals of 360°/n, where n is the number of mounting recesses/openings.

The opening for the port channel may be provided at the center of the port flange and present a shape and size which is substantially the same as those of the through port channel.

The through port channel 24, 34, 44, 54, 64, 74 connects an opening in the system interface surface 22′, 32′, 42′, 52′, 62′, 72′ to a corresponding opening in a heat exchanger surface 23′, 33′, 43′, 53′, 63′, 73′.

The through port channel has a port channel width and a port channel height or length extending from the system interface portion to the heat exchanger. Typically a length to width ratio may be on the order of 1:1 to 1:6, preferably 1:2 to 1:5, most preferably 1:3 to 1:4 for vehicular applications.

The mounting recess(es) 25, 35, 45, 55, 65, 75 provide openings in the system interface surface for, preferably releasable, attachment of the port flange to the system.

The purpose of the mounting recess(es) are to receive an attachment device, such as a screw, bolt or rivet. The mounting recess(es) may be accessible from the system interface portion 22, 32, 42, 52, 62, 72. The mounting recess(es) may be a through recess, i.e. the recess may extend from the system interface portion to the heat exchanger mounting portion, or they may be provided as a respective bottom recess having sufficient depth to receive the intended mounting device. As an example the depth may be 5 to 40 mm, preferably 10 mm to 30 mm, most preferably 15 mm to 20 mm. Standard bolt dimensions such as M6, M8 etc. may be used.

In the case of through mounting recesses, they may be attached also to the heat exchanger mounting portion and hence also the exchanger mounting portion may be provided with openings for attachment devices.

The mounting recess(es) may be generally cylindrical, but it may also have any other shape such as e.g. conical, frustoconical or having the shape of a rectangular parallelepiped, depending on the type of attachment device that is to be used.

The opening of the mounting recess(es) may be circular, or it may have any other shape such as e.g. rectangular or elliptical.

The port channel and the mounting recess(es) may be provided by the interior of a respective mounting recess sleeve 27, 37, 47, 57, 67, 77 and a port channel sleeve 26, 36, 46, 56.

Each sleeve may be defined by an outer width of 5 to 100 mm, preferably 10 to 90 mm, most preferably 15 to 80 mm, and an outer height of 5 to 40 mm, preferably 10 mm to 30 mm, most preferably 15 mm to 20 mm . The sleeve has walls which may have a thickness of 1 to 10 mm, preferably 2 to 8 mm, most preferably 3 to 6 mm.

In the case of a mounting recess sleeve, the interior of the sleeve, i.e. the mounting recess, may be threaded (female thread) if using a screw or bolt as attachment means, or it may be non-threaded if using any other type of attachment means, such as e.g. nut-and-bolt or rivet.

In the case of a through port channel sleeve, the interior of the sleeve, i.e. the port channel, may be generally smooth and cylindrical or frustoconical. As an alternative, the port channel may be non-straight and, for example, providing a bend through 0°-90°. In the latter case, the port channel may be provided by a pipe.

The heat exchanger mounting portion, which is optional, provides an increased heat exchanger interface surface 23′, 33′, 53′, 63′, 73′, which is intended to provide a sealed contact against the heat exchanger stack.

Similar to the system interface surface described above, the heat exchanger mounting surface may be planar, or it may be non-planar in order to fit to a corresponding non-planar shape of the heat exchanger, possibly with a sealing device (sealing gasket, sealing compound, etc.) arranged there between.

The heat exchanger mounting portion 23, 33, 43, 53, 63, 73 may be defined, like the system interface portion 22, 32, 42, 52, 62, 72 by a width, if applicable a widest and a narrowest width, and a length. Typically a length to width ratio may be in the order of 1:1 to 1:4, preferably 1:2 to 1:3.

The port flange has a thickness in a direction parallel with the port channel, and a length and a width in a main plane, which is perpendicular to the port channel.

The port flange may be made of one or several different parts which may be assembled as described for the different embodiments below.

Furthermore, the port flange may be made of one or several different materials, for example of stainless steel and/or carbon steel, aluminum etc., which are possible to join to each other with for example brazing, welding, or by attachment devices.

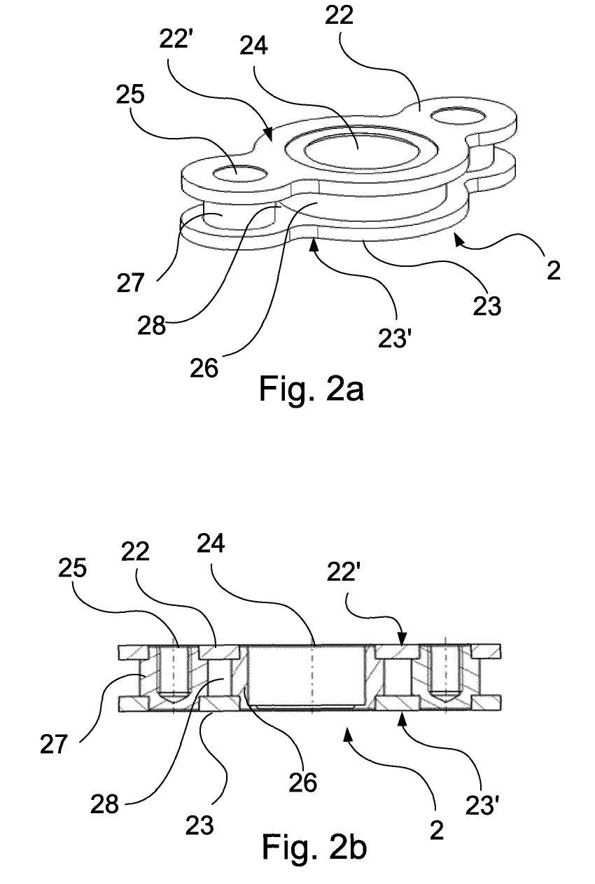

In FIGS. 2a-2b, a port flange 2 according to a first embodiment is schematically illustrated. The port flange may have a system interface portion 22, a heat exchanger mounting portion 23, a through port channel 24, two mounting recesses 25, a sleeve providing the through port channel 26 and sleeves providing the mounting recesses 27.

This port flange has a generally elongate shape, as seen in the main plane, but it may have any other shape, such as e.g. elliptic, annular or polygonal.

The size of the system interface portion 22 is defined by a length and a width, if applicable a widest and narrowest width. Typically a length to width ratio may be on the order of 1:1 to 1:4, preferably 1:2 to 1:3.

The system interface portion may be formed from a substantially planar member, which may have a thickness on the order of 1 to 8 mm, preferably 2 to 7 mm, most preferably 3 to 6 mm.

The system interface portion may be formed by a plate.

The shape of the heat exchanger mounting portion 23 may be the same as the shape of the system interface portion, e.g. a generally elongate shape. However, as an alternative the heat exchanger mounting portion may have a shape which is different from that of the system interface portion, and/or be smaller or larger.

The heat exchanger mounting portion may be formed by a plate which has a thickness which is thinner than the total thickness of the port flange.

The through port channel 24 may be provided by a sleeve, a pipe or a rod.

The port flange has mounting recess(es) 25 and in the port flange shown in FIGS. 2a-2b they do not reach all the way through, the heat exchanger mounting portion lacks openings for mounting recesses.

An assembly interface of the sleeve, i.e. a portion of the sleeve, pipe or rod which is to be used for interconnecting the sleeve with other parts making up the port flange, may present an axial height and a radial depth with respect to the through recess/sleeve.

The assembly interface may have a shoulder 29 or a taper (not shown) extending around an opening edge portion of the sleeve or pipe. An axial height of such a shoulder or taper may be substantially the same as the thickness of the system interface portion 22 and/or the heat exchanger mounting portion 32, as the case may be, in order to facilitate attachment between the sleeve and the system interface portion and/or to the heat exchanger mounting portion. The taper or shoulder may facilitate the assembly and increase the strength of the connection. A corresponding shoulder or taper may be provided in the opening of the system interface portion and/or on the heat exchanger mounting portion. As an alternative, the assembly interface may be straight.

The port flange presents a space 28 which is at least partially situated between the through port channel 24 and one of the mounting recesses 25.

In FIGS. 2a-2b this space 28 is shown as a hollow space/cavity, but alternatively, as described above, it may include a material different from the material(s) which the system interface portion and the heat exchanger mounting portion are made of. Such a material may have a lower density and/or a lower heat conductivity than the material of which all, or some, of the flange is made of.

The system interface portion 22, the heat exchanger 23 and the sleeves 27 for the mounting recesses 25 and/or the through port channel 24 may be made of for example of forged or casted bodies. As an alternative, the sleeves may be made by turning. As a further example, the system interface portion and the heat exchanger mounting portion may be formed by a cutting operation, such as punching.

Some or all of the pieces may be manufactured in one piece, or as several different pieces which may be assembled through for example press fitting, brazing, welding, by threaded connection(s), or by a combination of two or more of these methods. If brazing different parts together, a space for the solder, or an entry for the solder from the outside may be provided.

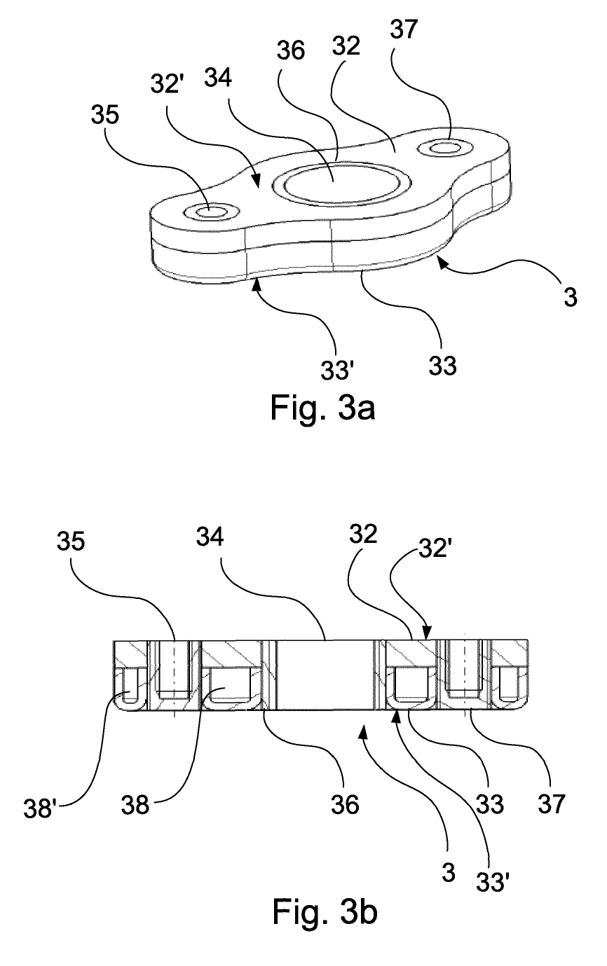

In FIGS. 3a-3b a port flange 3 according to a second embodiment is schematically illustrated. The port flange may have a system interface portion 32, a heat exchanger mounting portion 33, a through port channel 34, two mounting recesses 35 and sleeves for the through port channel 36 and for the mounting recesses 37.

The port flange has a generally elongated shape. However, it may have any other shape such as e.g. annular.

The system interface portion may, but need not, be thicker as compared to the system interface portion shown in FIG. 2a and FIG. 2b. The system interface portion may be manufactured by e.g. forging, casting or punching a plate blank.

In contrast to the port flange described above, the heat exchanger mounting portion 33 is formed from a planar member having portions thereof bent or formed so as to extend towards the system interface portion 32. For example, the heat exchanger mounting portion may be formed by deep-drawing of a planar blank.

The bent portions may be bent about 90 degrees towards the system interface portion such that edges of the bent portions and the system interface portion abut. The edges of the bent portions of the heat exchanger mounting portion 33 may be attached to the system interface portion and to the sleeves by e.g. brazing or welding. As an alternative, the bent portions may be shorter, hence not abutting the system interface portion and instead being attached to the sleeve of the through port channel and/or the sleeves of the mounting recesses at a distance from the system interface.

The port flange 3 further has a space 38 at least partly enclosed by the heat exchanger mounting portion 33 and the system interface portion 32.

The mounting recesses and the through port channel may, but need not be provided by sleeves 36, 37. These sleeves may be provided as discussed above.

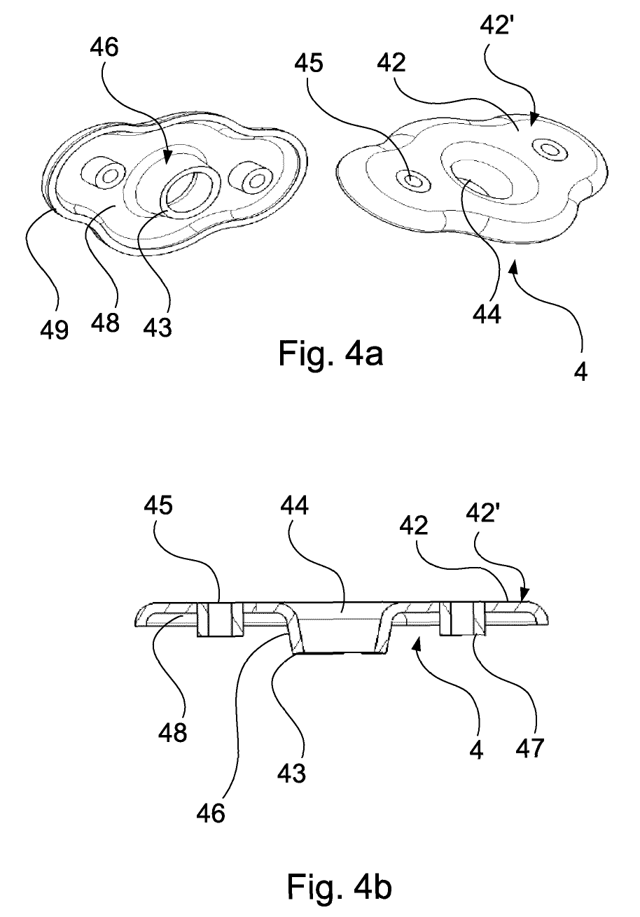

In FIGS. 4a-4b a port flange 4 according to a third embodiment is shown. The port flange may have a system interface portion 42, a through port channel 44 and one or more sleeves 46, 47 for the through channel port and/or for the mounting recesses. The port flange according to this embodiment may not have any separate part providing a heat exchanger mounting portion hence, the heat exchanger mounting portion 43 may be provided as an integrated portion of the sleeve providing the through port channel 44.

The port flange has a space 48 at least partly situated between the through port channel sleeve 46 and the mounting recess sleeve 47.

The system interface portion may be provided, e.g. by casting, forging etc. Further, the outer edges 49 of the system interface portion may be downwardly folded towards the heat exchanger, making the system interface portion 42 and hence the port flange 4 more rigid. The edges may be folded about 90 degrees thereby being parallel with the mounting recesses 45. The edges may be folded all the way such that they abut the heat exchanger upon mounting, or they may be folded such that it runs in parallel only a part of the length of the sleeves 46, 47 for the mounting recesses and/or the through port channel, respectively.

The sleeves 47 for the mounting recesses may be provided all the way between the system interface portion 42 to the heat exchanger and be through such that the attachment means may be secured to both the system interface and the heat exchanger (if provided with opening(s)). As an alternative they may be shorter and only possible to secure to the system interface. As described above, the sleeves may, but need, not be threaded.

The through port channel 44 may be provided as discussed above, e.g. as a cylindrical or frustoconical sleeve, or by a pipe and in FIG. 4a-4b it is provided as a frustoconical sleeve. However, in contrast to the embodiments above, one of the ends of the through port channel sleeve, preferably the narrowest one in the case of a frustoconical sleeve, may constitute the integrated heat exchanger mounting portion 43.

The integrated heat exchanger mounting portion 43 provided by the through port channel sleeve 46 may be brazed or welded onto the heat exchanger. The sleeves for the attachment devices may be mounted after mounting the port flange on the heat exchanger, and may be riveted onto the port flange 4. The through port channel 44 may be formed in the same piece as the plate-shaped member which forms the system interface portion 42, e.g. by deep drawing.

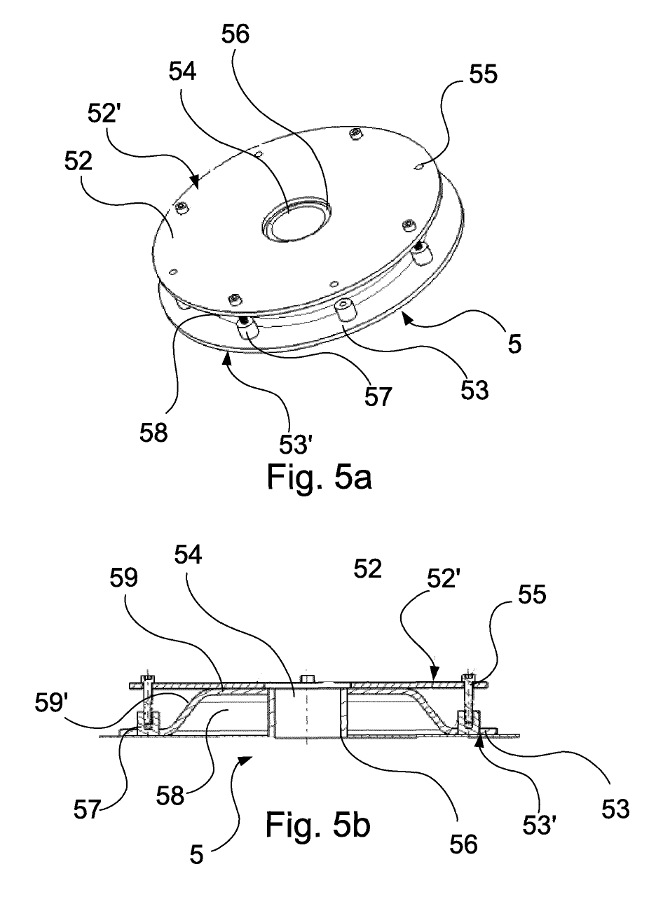

In FIGS. 5a-5b a port flange according to a fourth embodiment is shown. The port flange 5 may have a system interface portion 52, a heat exchanger mounting portion 53, at least one through port channel 54, a plurality of mounting recesses 55 and sleeves 57 for the mounting recesses.

The system interface portion may be formed by a plate-shaped member. In contrast to the port flanges 2, 3, 4 discussed above, the system interface portion 52 of this port flange may, but need not, have a circular shape. As an alternative the port flange may have elliptical or polygonal shape. Further, the system interface portion may have at least one opening for a through port channel 54. Openings for a plurality of mounting recesses 55 may be positioned at a uniform distance from each other around the opening of the through port channel 54 as described above.

Also the heat exchanger mounting portion 53 may be provided by a plate-shaped member. Similar to the system interface portion, the plate-shaped member may, but need not, have a circular shape.

The heat exchanger mounting portion 53 may abut the heat exchanger in the longitudinal direction and then extend towards the system interface portion in a transverse direction by means of a transition portion 59′. Further, an intermediate portion 59 may abut a lower side of the system interface surface 52′ of the system interface portion 52 in the longitudinal direction.

Onto the heat exchanger mounting portion, sleeves 57 are provided at corresponding positions of the openings 55 in the system interface portion 52. The purpose of those sleeves 57 is to receive attachment devices 57′, e.g. screws, bolts or rivets, for securing the system and the heat exchanger mounting portion 53. The sleeves 57 may, but need not, be threaded. As can be seen in FIGS. 5a and 5b, the length of the attachment devices 57′ may be longer, since they extends all the way from the system interface portion to the heat exchanger mounting portion, as compared to the attachment devices used in the previously discussed embodiments above. As an alternative, the sleeves 57 receiving the attachment devices may be shallower or shorter.

The through port channel 54 extends from the surface interface portion to the heat exchanger mounting portion and may be provided by a sleeve 56 as described above.

A space 58 may be provided in an area which is at least partly enclosed by the plate-shaped system interface portion 59, 59′, the heat exchanger and the port channel sleeve 56.

The system interface portion may be manufactured by for example cutting or punching a sheet blank, casting or forging. The heat exchanger mounting portion 53 may be manufactured by e.g. deep drawing, casting or forging. The sleeves 56, 57 for the through port channel and the mounting recesses may be manufactured by e.g. casting or forging. The heat exchanger mounting portion 53 may e.g. be welded onto the heat exchanger.

The port flange may be assembled through press fitting, attachment means such as screws, rivets, bolts, etc., and/or by brazing and/or welding the different parts together.

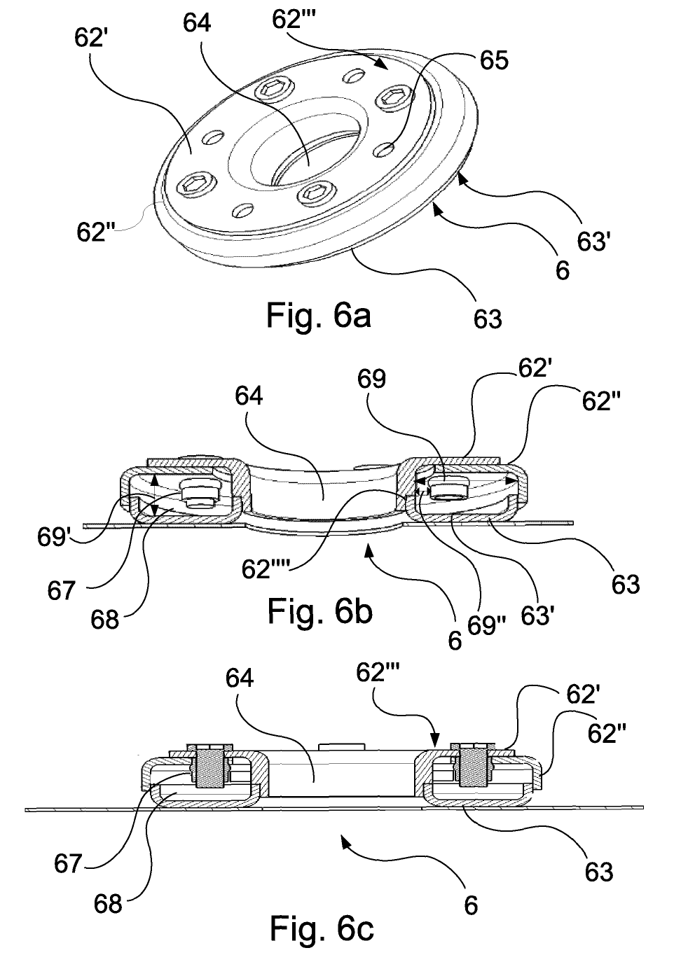

A fifth embodiment of a port flange is illustrated in FIGS. 6a-6b. The port flange 6 may have a system interface portion 62′, an enclosing portion 62″, a heat exchanger mounting portion 63, a through port channel 64, a plurality of mounting recesses 65 and sleeves for the mounting recesses 67. The system interface portion 62′, enclosing portion 62″ and heat exchanger mounting portion 63 may preferably be formed of plate-shaped members, which are possible to form to a desired shape.

The port flange may have an annular shape as shown in FIGS. 6a-6c, or it may have any other shape, e.g. an elliptic or polygonal.

A space 68 is enclosed inside the port flange, i.e. it is enclosed by the system interface portion 62′, the enclosing portion 62″ and the heat exchanger mounting portion 63.

The system interface portion may have an interface surface forming portion 62′″ and a channel forming portion 62′, providing at least part of the port channel 64. The channel forming portion 62′ (i.e. system interface portion) may, but need not, have a varying thickness, which may comprise a step 62″ arranged on the side opposite to the port channel surface. As an alternative, the system interface portion 62′ and the heat exchanger mounting portion 63 may have the same thickness and instead abutting and/or overlapping each other.

The heat exchanger mounting 63 portion may present a mounting surface 63′. The mounting surface may be a plate-shaped member presenting a main plane wherein the edges of the main plane are bent such that they may extend perpendicular towards the system interface portion 62′. A radially inner side of the heat exchanger mounting portion 63 may abut the inside of the channel forming portion 62′ and a radially outer side of the heat exchanger mounting portion 63 may abut and/or overlap the enclosing portion 62″.

The enclosing portion 62″ may have a first portion which is parallel with the system interface contact forming portion 62′ and a second portion which is parallel with one of the flanges of the heat exchanger mounting portion 63. The first portion of the enclosing portion may abut and at least partly overlap with the system interface portion 62′.

As discussed above, the through port channel 64 may be at least partly formed of the system interface portion 62′. Preferably the port channel is formed in the center of the port flange 6.

A distance 69 between an inner side of the enclosing portion 62″ and an inner side of the system interface portion 62′ in the longitudinal direction may be have a size of 10 to 40 mm, preferably of 15 to 35 mm.

A distance 69′ between an inner side of the heat exchanger mounting portion 63 and an inner side of the enclosing portion 62″ in the vertical direction may have a size of 10 to 30 mm, preferably 12 to 25 mm.

Furthermore, a distance 69″ between an outer side of a sleeve providing a mounting recess or an outer side of an attachment device in the case of not using a sleeve, and an inner side of the system interface portion 62′ in the longitudinal direction may have a size of 1 mm to 10 mm, preferably 2 mm to 7 mm.

Mounting recesses 65 may be provided by the enclosing portion 62″ and the system interface portion 62′ or by sleeves 67 between the system interface portion and the enclosing portion. Hence, there may be openings for the mounting recesses 65 in both these two portions. Preferably these mounting recesses may be provided uniformly around the port channel 64 as described above, and as an example an annular port flange may have nine mounting recesses, as in FIG. 6b. The mounting recesses may, but need not, be threaded.

As the port flange 6 may be made of up to three different parts, it may be made of the same or different materials for example of stainless steel or carbon steel, which are possible to join to each other.

The parts forming the system interface portion 62′ and the heat exchanger mounting portion may be formed by e.g. deep drawing, casting, forging or milling while the mounting recess sleeves 67 may be provided by e.g. casting or forging.

Upon assembly of the different parts, the flanges of the heat exchanger mounting portion 63 may attached to the channel forming portion of the system interface portion 62′ and to the enclosing portion 62″ by e.g. brazing or welding. The system interface portion and the enclosing portion may be attached to each other either by attachment devices or by a combination of attachment devices and brazing or welding.

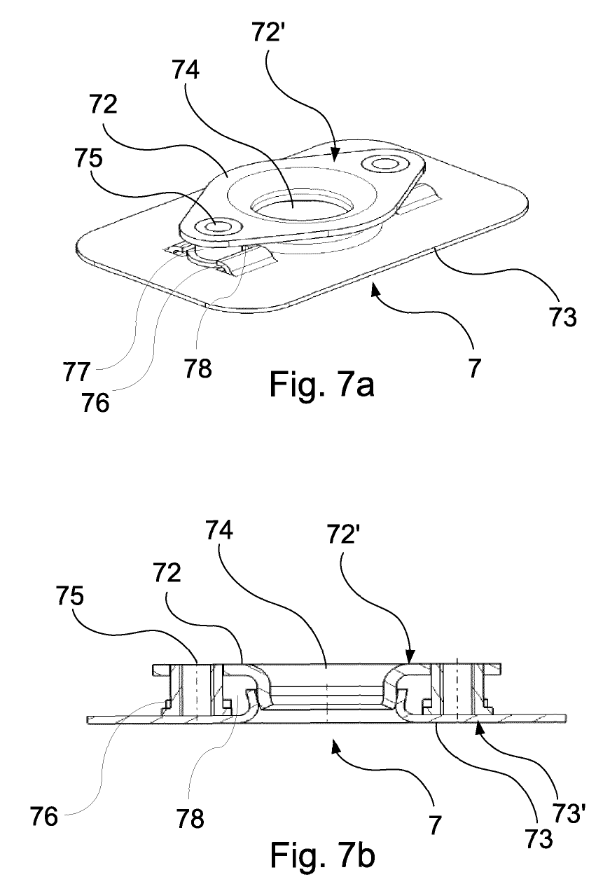

A sixth embodiment of a port flange is illustrated in FIGS. 7a-7b. This port flange 7 may have a system interface portion 72, a heat exchanger mounting portion 73, a through port channel 74 and mounting recesses for attachment devices 75.

When viewed from above, the system interface portion 72 may have a generally elongate shape which is widest at a center portion and tapers at the edges. However it may have any other shape, such as for example elliptic, or polygonal. Preferably the system interface portion is made of a plate-shaped member.

The heat exchanger mounting portion 73 may have a rectangular shape. The heat exchanger mounting portion may have any other shape, such as for example elliptic or polygonal. The system interface portion and the heat exchanger mounting portion may have the same or different shapes.

Similar to the system interface portion, the heat exchanger mounting surface may be made of a plate-shaped member. However, in contrast to the previously discussed embodiments, the heat exchanger mounting portion in FIGS. 7a-7b has at least one partially cut out tongue 76 which provides a positive interlocking connection with a flange part arranged on a sleeve 77 forming the mounting recess 75.

The through port channel 74 may be formed by a first channel forming part 72″ which may be formed in one piece with the system interface portion 72 and a second channel forming part 73″ which may be formed in one piece with the heat exchanger mounting portion 73. The first and second channel forming portions 72″, 73″ may be bent about 90 degrees towards each other such that they are parallel with the sleeves providing the mounting recesses 75. The first channel forming portion and the second channel forming portion extends towards each other, such that they abut and/or overlap each other thus forming the through port channel. The channel forming portions may be attached to each other by, for example by brazing or welding.

The mounting recesses 75 may be provided by sleeves 77 which extend between the system interface portion 72 and the heat exchanger mounting portion 73. The sleeves may have flanges at least at one of the ends providing the positive interlocking connection described above.

At space 78 is situated at least partly between the port channel 74 and the sleeves 77 for the attachment devices.

The system interface portion 72 and the heat exchanger mounting portion 73 which also provide the through port channel 74 may be manufactured by e.g. deep drawing and the sleeves for the mounting recesses may be manufactured by e.g. casting or turning.

The heat exchanger mounting portion 73 may be attached to the heat exchanger by brazing or welding. The first and second channel forming portions 72″, 73″ may be provided after attaching the heat exchanger mounting portion to the heat exchanger. The sleeves 77 providing the mounting recesses may be mounted, e.g. by riveting, brazing, threading, welding or press fitting after attaching the heat exchanger mounting portion to the heat exchanger.

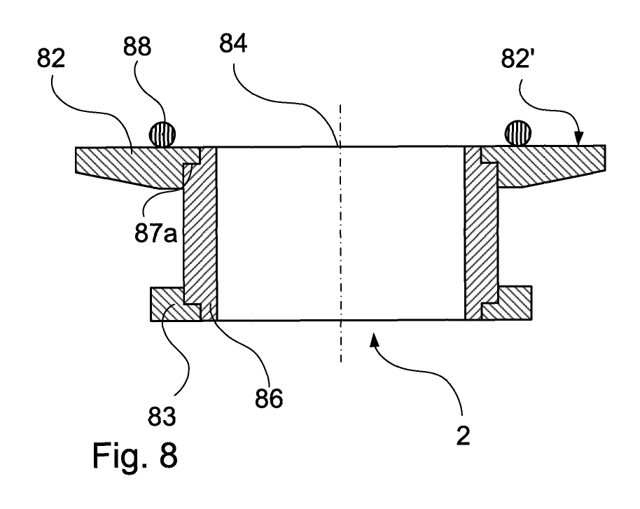

FIG. 8 is a schematic cross sectional view of a port flange according to a further embodiment, wherein no mounting recesses are provided. Instead, the port flange may be formed as a substantially rotationally symmetric part, comprising a first flange forming part of a system interface portion 82, a sleeve 86 forming a channel portion 84 and a second flange 83 forming part of a mounting portion.

The first flange 82 may be formed from a planar member, which has been e.g. stamped or cut into a suitable shape, such as annular. Optionally, the first flange may be provided with a mounting shoulder 87. Moreover, the first flange may have a thickness which tapers in a direction radially outwardly, which may facilitate assembly using a V clamp.

A sealing member 88, such as an O-ring may be positioned at the interface surface 82′. Optionally, an annular groove (not shown) may be provided in the interface surface. Such a groove would extend axially into the interface surface.

The second flange 83, which is optional, may be formed from a planar member, which has been e.g. stamped or cut into a suitable shape, such as annular. Optionally, the second flange 83 may be provided with a mounting shoulder.

The channel forming portion 86 may be designed as described with reference to FIG. 2a-2b.

1-37. (canceled)

38. A port flange for a heat exchanger, comprising:
a heat exchanger mounting portion;
a system interface portion;
at least one port channel connecting respective openings in the heat exchanger mounting portion and the system interface portion; and
at least one mounting recess which is accessible from the system interface portion, wherein the port flange presents a space situated between the port channel and the mounting recess, and wherein the space has lower density than at least one of the heat exchanger mounting portion or the system interface portion, and wherein the heat exchanger mounting portion is formed from a generally planar member having a thickness which is less than a total thickness of the port flange.

39. The port flange of claim 38, wherein the mounting recess is formed by a separate part, which is permanently joined to the system interface portion.

40. The port flange of claim 39, wherein the separate part comprises a second sleeve having an internal recess forming the mounting recess.

41. The port flange of claim 38, wherein the system interface portion is formed from a first generally planar member, having a thickness which is less than a total thickness of the port flange.

42. The port flange of claim 38, wherein the port channel is formed by a separate part, which is joined to the system interface portion.

43. The port flange of claim 42, wherein the separate part comprises a first sleeve having a length corresponding to a total thickness of the port flange, and wherein the first sleeve has an internal cavity forming the port channel.

44. The port flange of claim 43, wherein the separate part comprises a second sleeve having an internal recess forming the mounting recess.

45. A port flange for a heat exchanger, comprising:
a heat exchanger mounting portion configured to connect to a heat exchanger plate;
a system interface portion comprising a flange configured to connect to a system that is to supply or receive a medium to/from the heat exchanger; and
a port channel configured to connect an opening in the system interface portion to the heat exchanger mounting portion, wherein at least part of the port channel is formed from a first piece of material, and wherein the flange is formed of a second piece of material, and wherein the first piece of material is permanently joined to the second piece of material.

46. The port flange of claim 45, wherein the first piece of material is a tubular part.

47. The port flange of claim 45, wherein the second piece of material is a substantially planar part.

48. The port flange of claim 45, wherein the first piece of material is joined to the second piece of material by an operation comprising heat treatment of at least one of the materials, such as a brazing, soldering or welding operation.

49. A heat exchanger having at least one port flange, the at least one port flange comprising:
a heat exchanger mounting portion configured to connect to a heat exchanger plate;
a system interface portion comprising a flange configured to connect to a system that is to supply or receive a medium to/from the heat exchanger; and
a port channel configured to connect an opening in the system interface portion to the heat exchanger mounting portion, wherein at least part of the port channel is formed from a first piece of material, and wherein the flange is formed of a second piece of material, and wherein the first piece of material is permanently joined to the second piece of material as claimed in any one of the preceding claims mounted thereon.

50. A method of forming a port flange for a heat exchanger, the port flange comprising a system interface portion, a port channel extending from a first opening in the system interface portion, and a heat exchanger mounting portion for mounting the port flange to the heat exchanger, the method comprising:
forming at least two of the system interface portions, the port channel, and the mounting portion from two different parts; and
permanently joining the two different parts to form the port flange, wherein at least one of the parts is formed from a planar blank, such as a metal sheet, by one or more of stamping, pressing, or deep drawing.

51. A method of forming a port flange for a heat exchanger, the flange comprising a system interface portion, a port channel extending from a first opening in the system interface portion, and at least one mounting recess extending from a second opening in the system interface portion, the method comprising:
providing a first part defining the system interface portion and having the first opening and the second opening;
providing a sleeve defining a recess;
permanently joining the sleeve to the first part such that the first or second opening provides access to the recess, thus forming at least one of the port channel or the at least one mounting recess; and
providing the other one of the port channel or the mounting recess such that the port flange presents a space situated between the port channel and the mounting recess, wherein the space has a lower density than one or more of the heat exchanger mounting portion or the system interface portion.

52. A method of forming a port flange for a heat exchanger, comprising a heat exchanger mounting portion configured to connect to a heat exchanger plate, a system interface portion comprising a flange configured to connect to a system that is to supply or receive a medium to/from the heat exchanger, and a port channel configured to connect an opening in the system interface portion to the heat exchanger mounting portion, the method comprising:
forming at least part of the port channel from a first piece of material,
forming the flange from a second piece of material, and
permanently joining the first piece of material to the second piece of material,

53. The method of claim 52, wherein the first piece of material is formed from a substantially planar blank such as a metal sheet, and wherein the second piece of material is formed from an elongate member comprising a channel, such as a sleeve.

54. The method of claim 52, wherein the sleeve is connected to the system interface portion through at least one of press fitting, welding, or brazing.

55. The method of claim 52, wherein the permanent joining is provided by a process comprising heating at least part of the first and second pieces of material, and wherein the process comprises one or more of brazing, soldering, or welding.

56. The method of claim 52, wherein the permanent joining is provided simultaneously with the assembly of the heat exchanger.
